(19) United States
(12) Patent Application Publication
(10) Pub. No.: US 2006/0230859 A1
(43) Pub. Date: Oct. 19, 2006

(54) Gear shift head with function key

(75) Inventor: Jiun-Hung Lin, Hsen-kang Hsiang (TW)

Correspondence Address: NIKOLAI & MERSEREAU, P.A., 900 SECOND AVENUE SOUTH, SUITE 820, MINNEAPOLIS, MN, 55402, US

(73) Assignee: GD Tech Co., Ltd., Changhua Hsien (TW)

(21) Appl. No.: 11/156,696

(22) Filed: Jun. 20, 2005

(30) Foreign Application Priority Data
Mar. 31, 2005 (TW) 094110279

(51) Int. Cl. B60K 17/04

(52) U.S. Cl. 74/473.12

(57) ABSTRACT

A gear shift head has a first hemisphere and a second hemisphere. A key panel is mounted in the peripheral wall of the gear shift head. The key panel consists of a frame and a circuit board, and the circuit board transmits signals through electric wires or remote ways. The circuit board is covered with an elastic conductive layer such as conductive rubber, which has multiple contacts formed on an outer surface of the conductive rubber layer and corresponding to keys on a pad. A user can control auxiliary electronic devices of the vehicle via the keys on the gear shift head.

### BACKGROUND OF THE INVENTION

1. Field of the Invention

The present invention relates to a gear shift of a car, and particularly relates to a gear shift head with a function key, whereby auxiliary electronic devices in the car can be controlled conveniently.

2. Description of Related Art

At present, multi-functional devices such as a digital television, audio device, VCD, or a cellphone are fitted in vehicles. The operation of those electronic devices is generally through the instrument panel of the vehicle. However, it is inconvenient and dangerous to control the devices due to the distance between the instrumental panel and the driver. That is, the driver has to let go of the steering wheel etc, as well as transfer attention from the road conditions to the instrument panel, and these actions clearly constitute danger to the driver and those people around the vehicle.

Therefore, the invention provides a gear shift head with a function key to mitigate or obviate the aforementioned problems.

### SUMMARY OF THE INVENTION

The main objective of the present invention is to provide a gear shift head with a function key, whereby the driver of a vehicle can control auxiliary electronic devices safely and conveniently.

The gear shift head consists of a first hemisphere and a second hemisphere, and a recess is defined in a peripheral wall of the gear shift head to receive a key panel. The key panel has a frame and a circuit board therein, and the circuit board transmits electronic signals through electric wires or by remote ways such as infra red light. The circuit board is covered with an elastic conductive layer, and the elastic conductive layer has multiple contacts formed on an outer surface of the conductive layer corresponding to keys on a pad, whereby the driver can control the electronic devices conveniently and safely.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a first kind of a gear shift head in accordance with this invention;

FIG. 2 is a plan view of the first kind of the gear shift head in accordance with this invention;

FIG. 3 is a schematic illustration showing the first embodiment of the gear shift head mounted in the car; and

FIG. 4 is a plan view showing a second embodiment of the gear shift head in accordance with this invention

FIG. 5 is a perspective view showing a third embodiment of the gear shift head in accordance with this invention.

### DETAILED DESCRIPTION OF THE PREFERRED EMBODIMENT

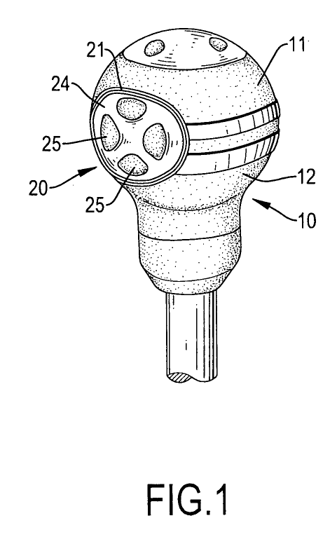

With reference to FIG. 1, a gear shift head (10) comprises a first hemisphere (11) and a second hemisphere (12). A key panel (20) is mounted at the peripheral wall of the two hemispheres (11), (12).

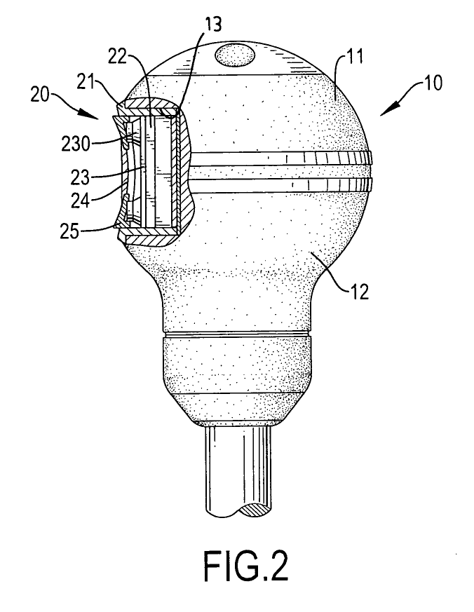

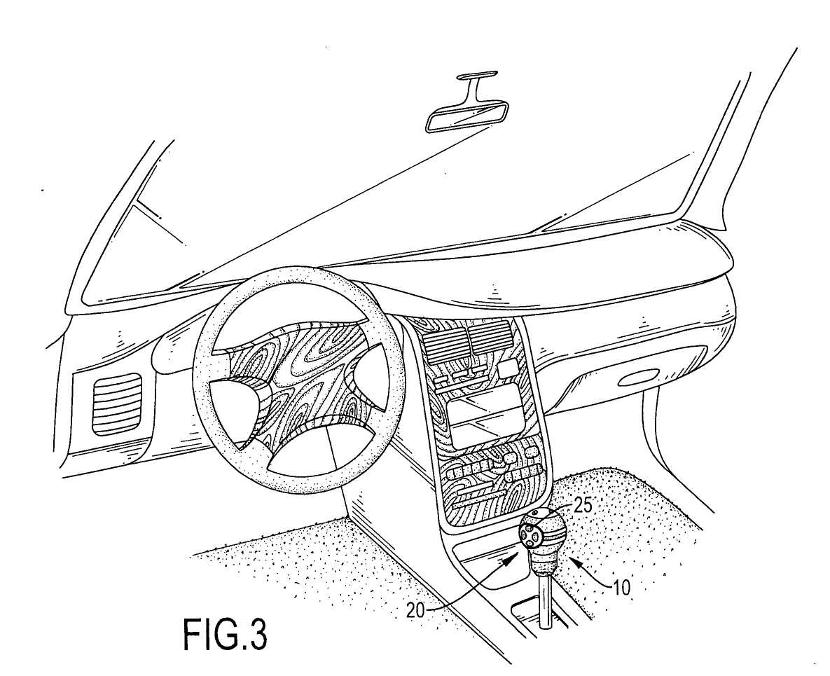

With reference to FIG. 2 and FIG. 3, a recess (13) is defined in the peripheral wall of the gear head (10) to receive the key panel (20). The key panel (20) has a frame (21) and a circuit board (22), and the circuit board (22) is accommodated in the frame (21). The circuit board transmits signals through electric wires or in a remote way such as infrared ray, Bluetooth™, low frequency RF (radio frequency) etc. The circuit board is covered with an elastic conductive layer such as conductive rubber (23), and multiple contacts (230) are formed on an outer surface of the conductive rubber (23). A pad (24) with a plurality of keys (25) is mounted on the conductive rubber (23) and the keys (25) correspond to the contacts (230). Every key (25) has its distinctive function like volume control, program switch, song selection etc, or some related function in reverse radar, digital television, cellphone and so on.

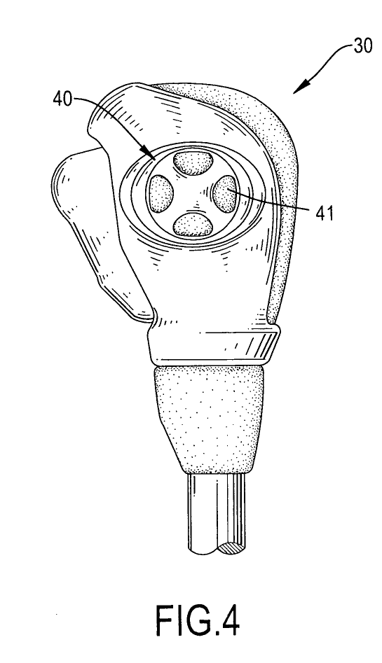

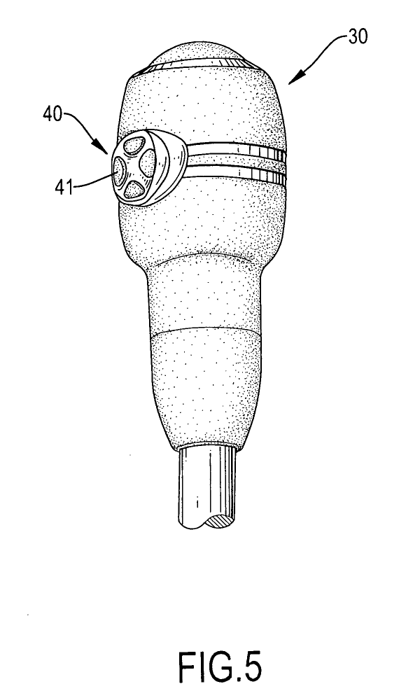

With reference to FIGS. 4 and 5, two different embodiments of gear shift head (30) are illustrated. The gear shift head (30) is a little longer than the gear head (10) in the first embodiment, and the key panel (40) with a plurality of keys is mounted in the peripheral wall of the gear head (30).

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A gear shift head for a vehicle, the gear shift head comprising:
a key panel (20), where the key panel (20) comprises:
a frame (21) received in a recess (13) defined in a peripheral wall of the gear shift head (10); and
a circuit board (22) accommodated in the frame (21) and covered with an elastic conductive layer, wherein multiple contacts (230) are formed on an outer surface of the elastic conductive layer, and a pad (24) with a plurality of keys (25) is mounted on the elastic conductive layer and the plurality of keys is corresponded to the contacts (230).

2. The gear shift head as claimed in claim 1, wherein the gear shift head further comprises a first hemisphere (11), a second hemisphere (12), and the key panel (20) is mounted between the two hemispheres.

3. The gear shift head as claimed in claim 1, wherein the elastic conductive layer is made of conductive rubber.
